(19) United States
(12) Patent Application Publication
(10) Pub. No.: US 2013/0178588 A1
(43) Pub. Date: Jul. 11, 2013

(54) Composite polymerization initiator and polymer brush composite obtained therefrom

(71) Applicants: Marco Avataneo, Senago Milano (IT); Giuseppe Marchionni, Milano (IT); Evgeny Denisov, Bollate (MI) (IT); Shiow-Ching Lin, Lawrenceville, NJ (US); Fabrizio Spada, Chelsea, VIC (AU); Bradley Lane Kent, Woolwich Township, NJ (US)

(72) Inventors: Marco Avataneo, Senago Milano (IT); Giuseppe Marchionni, Milano (IT); Evgeny Denisov, Bollate (MI) (IT); Shiow-Ching Lin, Lawrenceville, NJ (US); Fabrizio Spada, Chelsea, VIC (AU); Bradley Lane Kent, Woolwich Township, NJ (US)

(73) Assignee: SOLVAY SPECIALTY POLYMERS ITALY, S.P.A., Bollate (MI) (IT)

(21) Appl. No.: 13/825,361

(22) PCT Filed: Sep. 27, 2011
(86) PCT No.: PCT/EP11/66708

§ 371 Date: Mar. 21, 2013

Related U.S. Application Data
(60) Provisional application No. 61/387,899, filed on Sep. 29, 2010.

(30) Foreign Application Priority Data
Mar. 25, 2011 (EP) 11159849.6

(51) Int. Cl. C07F 19/00; C08F 14/22; C08F 20/14

(52) U.S. Cl. CPC C07F 19/00; C08F 20/14; C08F 14/22
USPC 525/55; 556/403; 526/194; 526/329.7; 526/255

(57) ABSTRACT

Composite polymerization initators are disclosed suitable to prepare polymer brush composites.

The composite initators comprise groups of formula (1):

-(L)ₙ-CR₂—B(R_{B1})₂ (1)

covalently anchored to the surface of a solid substrate. Disclosed are also a process for the preparation of the composite polymerization initiator as well as the polymerizaton process providing a polymer brush composite from said composite initiator.

This application claims priority to U.S. provisional application No. 61/387899—filed on 29 Sep. 2010 and to European application No. 11159849.6—filed on 25 Mar. 2011—, the whole content of each of these applications being incorporated herein by reference for all purposes.

### TECHNICAL FIELD

The invention relates to the general field of composite materials comprising a polymer anchored to the surface of a solid substrate. In particular the invention relates to a composite polymerization initiator comprising a solid substrate comprising free radical initiation sites covalently anchored distal to the substrate, to the polymer brush composite obtained therefrom as well as to a composition comprising the polymer brush composite.

### BACKGROUND ART

Fillers, which are solid additives in the form of particles or fibers, are widely used in the preparation of composite polymeric materials. Fillers are known to impart to the polymeric material properties such as increased gas barrier properties, increased mechanical, thermal and chemical resistance, improved melt processability, scratch and abrasion resistance as well as electrical conductivity, hydrophilicity and the like. The properties of the composite polymeric materials thus obtained often depend, among the others, on the extent of bonding between the polymeric matrix and the surface of the filler. As a matter of fact, poor dispersion between the filler and the polymeric matrix may even result in worsening of the polymer properties. Providing the surface of the solid with an organic character has been found to generally improve the dispersability of the solid phase into the polymeric one.

Composite materials comprising polymer chains bonded to solid substrates may advantageously improve the compatibility between the solid substrate and a polymeric matrix, in particular when the polymer chains bound to the substrate and the matrix have the same or similar chemical nature.

Composite materials comprising a solid substrate having a number of ordered polymeric chains covalently bonded to its surface are often referred to as “polymer brush composites”. Polymer brush composites may advantageously be obtained by providing the substrate surface with suitable reacting groups capable of initiating polymerization reactions and subsequently promoting said polymerization reactions from these surface bound initiating sites.

The Applicant has found that composite initiators comprising organoborane groups covalently anchored to the surface of a solid substrate are particularly suitable precursors of free radical polymerization sites for the preparation of polymeric brush composites starting from a wide range of monomers.

US 2008/0058454 A (TZE-CHIANG CHUNG) Jun. 3, 2008 discloses the use of organoborane compounds for the preparation of exfoliated fluoropolymer/clay nanocomposite. US 2008/0058454 A discloses a method whereby a chain-end functionalized fluoropolymer obtained by means of an organoborane initiator is reacted with a layered silicate clay producing the exfoliated nanocomposite. The nanocomposite may alternatively be obtained by in situ polymerization, by reacting a fluoromonomer, a functionalized radical initiator and the layered silicate clay; the functionalized radical initiator comprising a functional group capable of anchoring the initiator (either electrostatically, ionically or covalently) to the clay interface. This document however does not describe the preparation of composite polymerization initiators comprising organoborane groups covalently bonded to the surface of a solid support nor the polymer brush composites obtainable therefrom.

### SUMMARY OF INVENTION

A first object of the invention is a composite polymerization initiator comprising a solid substrate having organoborane groups covalently anchored to the surface of the solid substrate.

The expressions “free radical initiator” or “initiator” are used herein to refer to a compound that can provide a free radical under certain conditions such as heat, light, or other electromagnetic radiation, which free radical can be transferred from one monomer to another and thus propagate a chain of reactions through which a polymer may be formed.

The solid substrate may be organic or inorganic.

A second object of the invention is a method for preparing a composite initiator. In a first embodiment said method comprises: (a) providing a solid substrate comprising reactive groups on its surface; (b) reacting in a first step said solid substrate with a linker compound comprising one functional group capable of forming a covalent bond with the reactive groups on the surface of the solid substrate, and at least one functional group capable of forming a carbon-boron bond by reaction with an organoborane; and (c) reacting in a second step the so-obtained functionalized solid substrate with an organoborane.

In a second embodiment the method comprises: (a) providing a solid substrate comprising reactive groups on its surface; and (b) reacting said solid substrate with a compound comprising one functional group capable of forming a covalent bond with the reactive groups on the surface of the solid substrate, and at least one organoborane moiety of formula —CR₂B(R_{B1})₂.

In an aspect of the method the linker compound is an organosilane comprising a functional group capable of reacting with the surface reactive groups of the solid substrate and three non-hydrolizable groups (R_{N}′) directly bound to the Si atom, at least one of which comprising a carbon-carbon unsaturation of formula —CR═CR₂.

A further object of the invention is a process to prepare a polymer brush composite comprising: (a) providing a composite initiator comprising organoborane groups covalently attached to the surface of a solid substrate; and (b) contacting the composite initiator with monomers under conditions that promote free radical polymerization from organoborane groups to form a polymer brush. In particular the process comprises contacting the composite initiator comprising organoborane groups in the presence of oxygen with monomers capable to polymerize via a free radical route.

Another object of the invention is a polymer brush composite obtainable from the composite initiator. In an aspect of the invention said polymer brush composite comprises a solid substrate having polymer chains covalently anchored to the surface of the solid substrate, said polymer chains comprising recurring units deriving from fluorinated and/or perfluorinated monomers.

An additional object of the invention are compositions comprising the polymer brush composites. Of particular interest are compositions comprising a polymeric matrix and the polymer brush composites. The polymeric matrix may have the same or different composition than the polymer chains in the polymer brush. Both the polymer brush composite and the compositions obtained therefrom are particularly useful in the preparation of paints, coatings, varnishes, inks, toners as well as membranes for filtration purposes.

### DISCLOSURE OF INVENTION

In a first aspect the present invention relates to a composite polymerization initiator comprising groups of formula (1) covalently anchored to the surface of a solid substrate:

-(L)ₙ-CR₂—B(R_{B1})₂ (1)

At least one group of formula (1) is anchored to the surface of the solid substrate. Preferably more than one group of formula (1) is anchored to the surface of the solid substrate. The total number of groups of formula (1) is not limited and will generally depend on the nature as well as size of the solid substrate.

In formula (1) each R is independently selected from the group consisting of hydrogen, C₁-C₁₅ linear or branched alkyl groups, optionally comprising heteroatoms such as O, N, F, S. Preferably, each R is independently hydrogen or a C₁-C₆ linear or branched alkyl group. More preferably each R is hydrogen.

Each group R_{B1} may independently be selected from the group consisting of hydrogen, C₁-C₂₀, preferably a C₂-C₁₅, more preferably C₂-C₁₀, linear, branched or cyclic alkyl group. Each group R_{B1} may independently be selected from the group consisting of ethyl, propyl, n-butyl, cycloesyl. Each group R_{B1} may also be a C₅-C₁₀ aromatic group, optionally fluorinated. Each group R_{B1} may be comprised in an, optionally substituted, aliphatic or aromatic cyclic structure. Advantageously, the group —B(R_{B1})₂ may be an aliphatic bicyclic borane radical wherein both boron-carbon bonds are part of a cyclic structure, such as 9-borabicyclo[3.3.1]nonane, 9-borabicyclo[3.3.2]decane.

Linker group L is optional, thus n may be equal to 0 or 1. When n=0, the organoborane moiety —CR₂—B(R_{B1})₂ is directly bound to the substrate surface. In most cases however a linker group L may be preferred as it helps spacing the polymer chains in the polymer brush composite away from the substrate surface. Thus, n is preferably equal to 1. The nature of linker group L may be selected depending on the type of surface of the substrate. The linker group moieties generally are selected so that they do not interfere with the polymerization reaction.

The organoborane moiety —CR₂—B(R_{B1})₂ is bound to the substrate surface, optionally via linker group L, through only one attachment site. This can be accomplished for instance by selecting a linker compound that can react with only one reactive group present on the substrate surface.

More than one moiety —CR₂—B(R_{B1})₂ can be covalently anchored to the surface of the solid substrate via one linker group L. That, is linker group L can be multifunctional.

Suitable linker groups may be selected from the group consisting of substituted alkyl, heteroalkyl, arylene, heteroarylene groups including linker groups comprising silane, amine, ether, thioether moieties in the chain.

In an embodiment of the invention the linker group comprises an organosilane moiety.

The use of a linker group comprising a silane moiety is particularly advantageous when Si or SiO₂ based (such as silicon, silica, fused silica glass, quartz or other silicon based glasses), alumina or alumino-silicate substrates are used because silicon bonds readily to the hydroxyl groups present on the surface of such substrates.

Additional spacing may be provided separating the silicon atom from the the organoborane moiety.

In a preferred embodiment of the invention the composite initiator comprises groups of formula (1a) covalently anchored to the surface of the solid substrate:

-A-Si(R_{N})_{3-b}-(A′-CRR_{B2}—CR₂—B(R_{B1})₂)_{b} (1a)

In formula (1a) b is an integer equal to 1, 2 or 3. Preferably b is equal to 1 or 2.

Each R_{N}, equal or different from each other, is a non-hydrolyzable group, that is a group which is not displaced by water to form an OH group bound to the silicon atom. Suitable non-hydrolyzable groups are for instance linear or branched alkyl groups, typically a C₁-C₁₅, preferably C₁-C₆ linear or branched alkyl group, optionally comprising heteroatoms such as O, F, N, S. Each group R_{N} may also be a C₅-C₁₀ aromatic group, optionally fluorinated.

R_{B2} is selected from the group consisting of hydrogen, halogen, C₁-C₁₅ linear or branched alkyl. Preferably, R_{B2} is hydrogen.

Groups R and R_{B1} are as defined above.

A and A′, optionally present, equal or different from each other, are independently selected from C₁-C₁₀ alkyl, optionally substituted and/or optionally fluorinated and/or optionally comprising oxygen atoms in the chain, C₆-C₂₀ arylene or heteroarylene radical, a —Si(R_{N})₂— radical, an amino radical. Linear alkyl and alkoxy linker groups are generally preferred because they do not interfere with the subsequent free radical polymerization reaction promoted by the composite initiator. It is understood that when A and/or A′ are selected from C₁-C₁₀ alkyl linker groups comprising oxygen atoms in the chain they do not form any hydrolyzable silicon-oxygen bond.

Typically, group A is not present, that is the silicon atom is directly bonded to the functional surface site on the substrate. A′ is preferably a C₁-C₈ linear alkyl or alkoxy group.

The choice of the solid substrate in the composite initiator is not particularly limited. Generally, substrates having reactive groups on their surface, hereinafter referred to as GSR groups, are preferred. The reactive groups may be present on the substrate surface or alternatively the may be formed on the substrate surface by known derivatization techniques (e.g. plasma polymerization). Among suitable surface reactive groups GSR, mention can be made of hydroxyl groups, thiol groups, carboxyl groups, amino groups. Substrates having hydroxyl groups on their surface are generally preferred.

The substrate typically comprises at least one surface reactive group GSR, preferably more than one surface reactive groups GSR. The total number of groups is not limited and will generally depend on the nature as well as size of the substrate.

The substrate may take any desired size or shape, such as a square or round flat chip, a fiber, a platelet or a sphere. When in the form of particles they generally have an average particle size of 0.001 μm to 1000 μm, preferably of 0.01 μm to 800 μm, more preferably of 0.03 μm to 500 μm.

The solid substrate may be organic or inorganic or a mixture of the two. Among organic substrates mention can be made of carbonaceous materials, such as carbon black, carbon fibers, diamond like carbon, graphite, fullerenes, including spherical fullerenes and carbon nanotubes, polymeric materials, in particular those containing reactive groups such as poly(vinyl alcohol), cellulosic materials, wood fibers, lignin and the like.

Among inorganic substrates mention can be made of metals (e.g. gold, copper, iron, nickel, zinc, silicon); inorganic oxides, including mixed oxides (e.g talc, alumino-silicates, clays); metal sulphates (e.g. BaSO₄, CaSO₄), metal carbonates (e.g. marble, chalk); metal sulfides and the like. Among metal oxides, mention can be made of SiO₂, TiO₂, ZnO, Fe₂O₃, Cr₂O₃, Al₂O₃. Preferably the inorganic substrate is selected from metal oxides and mixed oxides. More preferably the solid substrate is selected from silica-based materials (e.g. silica, fused silica glass, quartz, nanosized silica), alumina, alumino-silicates.

The degree of functionalization in the composite initiator can be expressed as a normalized value representing the ratio of the available substrate surface reactive groups having an organoborane moiety attached thereto to the total number of such available substrate surface reactive groups. For example, when substantially all of the available substrate surface reactive groups have one organoborane moiety attached, then the surface is considered to have a degree of functionalization of 1. Similarly, when 25 percent of the available surface reactive groups have one organoborane moiety attached, then the surface is considered to have a degree of functionalization of 0.25. A degree of functionalization greater than 1 can be obtained when more than one organoborane moiety is attached to the substrate surface reactive groups, i.e. when using polyfunctional linker groups. The degree of functionalization can be adjusted, as may be desirable for a particular application. Typically, the degree of functionalization in the composite initiator of the invention ranges from 0.01 to 3, more typically from 0.1 to 1, even more typically from 0.15 to 0.8.

In a second aspect, the invention relates to a process for the preparation of the composite initiator of the invention, said process comprising: (a) providing a solid substrate comprising surface reactive groups GSR; (b) reacting the solid substrate with a compound comprising one functional group [X] capable of forming a covalent bond with the substrate surface by reaction with the surface reactive groups GSR, and at least one functional group either comprising a moiety of formula —CR₂—B(R_{B1})₂ or capable of forming a moiety —CR₂—B(R_{B1})₂ by reaction with an organoborane of formula B(R_{B1})₂R_{B2}.

In a first embodiment, the composite initiator can be prepared by a two step process. In the first step the solid substrate comprising surface reactive groups GSR is reacted with a linker compound of formula X-(L′)ₙ-Yₐ comprising one functional group X capable of forming a covalent bond with the substrate surface by reaction with the surface reactive group GSR, and at least one functional group Y capable of forming a carbon-boron bond by reaction with an organoborane of formula B(R_{B1})₂R_{B2}.

Functional group Y is typically, but not exclusively, an unsaturated carbon-carbon bond. More than one functional group Y may be present in the linker compound, that is a≧1. Typically, a is an integer equal to 1, 2, 3, 4, 5 and even up to 10. More typically a is equal to 1, 2, 3 or 4. Preferably, a is equal to 1, 2 or 3.

L′ is a linker group and n is equal to 0 or 1. Linker group L′ may be selected from the group consisting of substituted alkyl, heteroalkyl, arylene, heteroarylene groups including linker groups comprising silane, amine, ether, thioether moieties in the chain.

The Applicant has found that when compound of formula X-(L′)ₙ-Yₐ comprises only one functional group capable of reacting with the substrate reactive groups GSR better results are obtained, as no interaction between groups X on different linker compounds take place leading to parasitic reactions. These may lead to the formation of high molecular weight compounds which are then difficult to remove from the functionalized substrate.

The process may be represented by the following scheme (I):

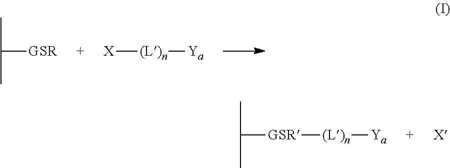

In scheme (I) X′ represents a leaving group that may optionally form in the reaction between linker compound X-(L′)ₙ-Yₐ and reactive group GSR; group GSR′ represents a bridging group or a direct bond formed in the same reaction.

The reaction is typically carried out in the presence of a solvent. Suitable solvents are for instance alkanes, aromatic solvents (e.g. benzene, toluene), ethers (e.g. tetrahydrofuran) as well as fluorinated solvents (e.g. hydrofluoropolyehters, perfluoropolyethers). The reaction may optionally be carried out in the presence of catalysts or suitable adjuvants to promote the reaction between groups GSR and X.

In a preferred embodiment of the process, the linker compound is an organosilane comprising one functional group X capable of forming a covalent bond by reaction with the surface reactive group GSR of the solid substrate and three non-hydrolyzable groups R_{N}′ directly bound to the Si atom at least one of which comprising a carbon-carbon unsaturation of formula —CR═CR₂, groups R being as defined above. In such an embodiment group —CR═CR₂ represents the functional group Y capable of reacting with an organoborane of formula B(R_{B1})₂R_{B2} and R_{B2} is hydrogen. In one embodiment, the organosilane may be represented by formula X—Si(R_{N}′)_{3-b}(A′-CR═CR₂)_{b}, wherein X, R_{N}′, A′, R and b are as defined.

Non-hydrolyzable groups R_{N}′ may be the same or different from the non-hydrolyzable groups present in the composite initiator of formula (1a). In general, groups R_{N}′ in the organosilane linker group not involved in the reaction with the borane B(R_{B1})₂R_{B2} (via functional group Y) will be the same as group R_{N} in the composite initiator.

When linker compound is an organosilane the Applicant has found that if less than three non-hydrolizable groups are bound to the silicon atom, side-reactions leading to the formation of by-products containing Si—Si bonds take place at the conditions in which the reaction between the substrate and linker compound is carried out. Additionally, non-hydrolizable groups present on the organosilane linker compound bound to the surface of the substrate may hydrolize or react during the second step of the process for preparing the composite initiator or even during the subsequent polymerization reaction for proeparing the polymer brush.

When the reactive group GSR on the surface of the solid substrate is an hydroxyl group, functional group X may be for instance OH, Cl, Br, I, ORs, wherein R_{S} is a C₁-C₆ alkyl group.

Examples of suitable silicon-based linker compounds are:

SiCl(R_{S})₂(CH═CH₂), Si(OR_{S})(R_{S})₂[(CH₂)ₘCH═CH₂] (m=1-6),

Si(OR_{S})(R_{S})₂[(C₆H₄)CH═CH₂], Si(OR_{S})(R_{S})₂[OC(O)CH═CH₂],

Si(OR_{S})(R_{S})₂[OC(O)C(CH₃)═CH₂], Si(OR_{S})(R_{S})₂[CH(CH₂OCH═CH₂)₂],

[(bicycloheptenyl)ethyl]dimethylchlorosilane.

In the second step of the process, the substrate comprising linker group -(L)ₙYₐ covalently bound to its surface is reacted with organoborane of formula B(R_{B1})₂R_{B2} providing the composite initiator of the invention comprising groups of formula (1) -(L)ₙ-CR₂—B(R_{B1})₂ covalently anchored to the surface of the solid substrate.

In general, group L′ of the linker compound X-(L′)ₙ-Yₐ will differ from linker group L in formula (1) for the group(s) that form in the reaction between functional group Y and the organoborane of formula B(R_{B1})₂R_{B2}.

In an embodiment of the invention linker compound X-(L′)ₙ-Yₐ comprises only one functional group Y═—CR═CR₂ (that is a=1). In such an embodiment after reaction of the solid substrate comprising anchored functional groups -(L′)ₙ-Y with organoborane B(R_{B1})₂R_{B2}, linker group (L)ₙ=(L)ₙ-CRR_{B2}— will covalently anchor functional group (1) to the surface of the substrate.

Examples of suitable organoboranes are for instance BH(C₂H₅)₂, B(n-C₄H₉)3,9-H-9-borabicyclo[3.3.1]nonane, 9-H-9-borabicyclo[3.3.2]decane. Preferably organoborane B(R_{B1})₂R_{B2} is 9-H-9-borabicyclo[3.3.1]nonane.

The process is typically carried out in two separate steps. Preferably, after the first step of the process the substrate comprising linker groups -(L)ₙYₐ attached to its surface is recovered and thoroughly dried before reaction with organoborane B(R_{B1})₂R_{B2}.

In a second embodiment, the composite initiator can be prepared by a process comprising: (a) providing a solid substrate comprising surface reactive groups GSR; (b) reacting the solid substrate with a compound of formula X-(L)ₙ-CR₂B(R_{B1})₂ comprising one functional group X capable of forming a covalent bond with the substrate surface by reaction with the surface reactive group GSR, and at least one organoborane moiety of formula —CR₂B(R_{B1})₂ to obtain a solid substrate comprising groups -(L)ₙ-CR₂B(R_{B1})₂ anchored to its surface. L, n, R and RB₁ have the meanings discussed above.

Compound of formula X-(L)ₙ-CR₂B(R_{B1})₂ can be prepared, for instance, by reaction of an organoborane of formula B(R_{B1})₂R_{B2} with a compound of formula X-(L′)ₙ-Yₐ comprising at least one functional group Y capable of forming a carbon-boron bond by reaction with an organoborane of formula B(R_{B1})₂R_{B2}.

Functional group Y is typically, but not exclusively, an unsaturated carbon-carbon bond; in such a case R_{B2} is hydrogen.

The reaction of compound of formula X-(L)ₙ-CR₂B(R_{B1})₂ with the solid substrate is typically carried out in the presence of a solvent. Suitable solvents are for instance alkanes, aromatic solvents (e.g. benzene, toluene), as well as fluorinated solvents (e.g. hydrofluoropolyehters, perfluoropolyethers). The reaction may optionally be carried out in the presence of catalysts or suitable adjuvants to promote the reaction between groups GSR and X.

In a further aspect, the invention relates to a process to prepare a polymer brush composite comprising: (a) providing a composite initiator comprising organoborane moieties of formula (1) -(L)ₙ-CR₂-B(R_{B1})₂ covalently anchored to the surface of a solid substrate; and (b) contacting the composite initiator with monomers capable to polymerize via a free radical route under conditions that promote free radical polymerization from groups of formula (1) to form a polymer brush.

The phrase “conditions that promote free radical polymerization” refers to those conditions, including the presence of heat or electromagnetic radiation, solvents, co-solvents, co-initiators which allow free radical formation and propagation.

In particular the process comprises contacting in the presence of oxygen the composite initiator with monomers capable to polymerize via a free radical route.

As disclosed in CHUNG, Tze-Chiang, et al. A Novel Stable Radical

Initiator Based on the Oxidation Adducts of Alkyl-9-BBN. Journal of the American Chemical Society. 1996, vol. 118, p. 705-708. organoborane compounds of general formula BR₃ in the presence of oxygen give rise to radical species which can initiate the free radical polymerization of certain monomers.

The amount of oxygen fed to the reaction is typically equal to or less than the stoichiometric amount with respect to the number of —B(R_{B1})₂ groups in the system. Typically the amount by moles of oxygen fed during the reaction is no more than 100% of the number of —B(R_{B1})₂ groups in the system. Typically, oxygen is fed in a step-wise fashion during the course of the polymerization reaction.

The polymerization process employing the composite initiator of the invention may be used to form a wide variety of polymers. Further, the process of the present invention can be selected to polymerize a mixture of two or more different polymerizable monomers to form copolymers therefrom.

The polymerization process proceeds with a “living” mechanism, that is a mechanism wherein chain initiation and chain propagation occur without significant termination reactions. Each initiator site produces a growing polymer chain which continuously propagates until all the available monomer has reacted. Living free radical polymerization processes typically produce polymers with controlled molecular weight distributions; they also allow the preparation of block copolymers by sequentially feeding different monomers to the growing polymer chain.

Monomers suitable in the preparation of the polymer brush composites are those that are capable of undergoing free radical polymerization.

Mention can be made of non-fluorinated monomers such as ethylene, propylene, butadiene, isoprene, vinyl monomers such as vinyl acetate, acrylic monomers, like acrylic acid, methacrylic acid, acrylate, methyl acrylate, ethyl acrylate, butyl acrylate, methyl methacrylate, as well as styrene monomers, like styrene, hydroxystyrene, and p-methylstyrene; N-vinyl pyrrolidone, N-vinyl imidazole.

Among the suitable perfluorinated monomers mention can be made of:
C₃-C₈ perfluoroolefins, such as tetrafluoroethylene, and hexafluoropropylene;
chloro- and/or bromo- and/or iodo-C₂-C₆ fluoroolefins, like chlorotrifluoroethylene;
(per)fluoroalkylvinylethers complying with formula CF₂═CFOR_{f1} in which R_{f1} is a C₁-C₆ fluoro- or perfluoroalkyl, e.g. CF₃, C₂F₅, C₃F₇;
CF₂═CFOX₀ (per)fluoro-oxyalkylvinylethers, in which X₀ is a C₁-C₁₂ alkyl, or a C₁-C₁₂ oxyalkyl, or a C₁-C₁₂ (per)fluorooxyalkyl having one or more ether groups, like perfluoro-2-propoxy-propyl;
(per)fluoroalkylvinylethers complying with formula CF₂═CFOCF₂OR_{f2} in which R_{f2} is a C₁-C₆ fluoro- or perfluoroalkyl, e.g. CF₃, C₂F₅, C₃F₇ or a C₁-C₆ (per)fluorooxyalkyl having one or more ether groups, like —C₂F₅—O—CF₃;
functional (per)fluoro-oxyalkylvinylethers complying with formula CF₂═CFOY₀, in which Y₀ is a C₁-C₁₂ alkyl or (per)fluoroalkyl, or a C₁-C₁₂ oxyalkyl, or a C₁-C₁₂ (per)fluorooxyalkyl having one or more ether groups and Y₀ comprising a carboxylic or sulfonic acid group, in its acid, acid halide or salt form;
fluorodioxoles, especially perfluorodioxoles.

Among suitable fluorinated monomers mention can be made of:
C₂-C₈ hydrogenated fluoroolefins, such as vinyl fluoride, 1,2-difluoroethylene, vinylidene fluoride and trifluoroethylene;
perfluoroalkylethylenes complying with formula CH₂═CH—R_{f0}, in which R_{f0} is a C₁-C₆ perfluoroalkyl.

Hydrogenated and/or fluorinated compounds comprising more than one carbon-carbon double bond can also be used as monomers in the present invention, for instance those of formulae below:
R₁R₂C═CH—(CF₂)ⱼ—CH═CR₃R₄ wherein j is an integer between 2 and 10, preferably between 4 and 8, and R₁, R₂, R₃, R₄, equal or different from each other, are hydrogen, fluorine or C₁-C₅ alkyl or (per)fluoroalkyl group;
G₂C═CB—O-E-O—CB═CG₂, wherein each of G, equal or different from each other, is independently selected from fluorine, chlorine, and hydrogen; each of B, equal or different from each other is independently selected from fluorine, chlorine, hydrogen and —OR_{b}, wherein R_{b} is a branched or straight chain alkyl radical which can be partially, substantially or completely fluorinated or chlorinated; E is a divalent group having 2 to 10 carbon atoms, optionally fluorinated, which may be inserted with ether linkages; preferably E is a —(CF₂)_{z}— group, with z being an integer from 3 to 5; a preferred bis-olefin is F₂C═CF—O—(CF₂)₅—O—CF═CF₂;
R₆R₇C═CR₅-E-O—CB═CG₂, wherein E, G and B have the same meaning as above defined; R₅, R₆, R₇, equal or different from each other, are hydrogen, fluorine or C₁-C₅ alkyl or (per)fluoroalkyl group.

Polymer brush composites comprising polymer chains comprising recurring units deriving from fluorinated and perfluorinated monomers, as detailed above, are particularly useful to improve the compatibility of solid substrates with fluorinated and/or perfluorinated polymer matrices which are typically poorly compatible with many fillers.

Known additives and/or polymerization adjuvants may be additionally present in the polymerization reaction, which additives may provide performance enhancements to the resulting product and/or process. Such additives may include lubricants, release or transfer agents, surfactants, stabilizers, antifoams, and the like.

The free radical polymerization is typically conducted for a sufficient amount of time and under the suitable reaction conditions, such that the desired conversion is achieved. The amount of time needed may depend upon the temperature of the polymerization. Typically, the polymerization is conducted from about 1 to about 20 hours, preferably from about 1.5 to about 10 hours.

The polymerization reactions may be conducted in a variety of media, for example suspension, emulsion, bulk, that is neat or without solvent, in non-aqueous solution. When used, suitable solvents include solvents that have comparably small chain transfer constants with the particular monomer(s) used in the polymerization.

The polymerization can be carried out at temperatures ranging from about −80° C. to 250° C., typically between −80° C. to 80° C., even between 0° C. to 70° C.

The process of the invention is carried out preferably as a batch process, but when needed can be carried out in any of the standard polymerization processes, for example semi-batch or continuous processes.

The invention further relates to polymer brush composites obtained from the polymerization reaction initiated by the inventive composite initiator.

In a first aspect said polymeric brush composite comprises a solid substrate and polymer chains covalently anchored to the surface of said substrate by means of groups of formula (2):

-((L)ₙ-CR₂)— (2)

In formula (2) L, n and R have the meanings already defined.

In an aspect of the invention said polymer brush composite comprises a solid substrate having polymer chains covalently anchored to the surface of said substrate by means of groups of formula (2a):

-(A-Si(R_{N})_{3-b}(A′-CRR_{B2}CR₂)_{b})— (2a)

In formula (2a) A, A′, R, R_{N}, R_{B2} and b have the above defined meanings.

The polymer chains covalently anchored to the surface of the solid substrate comprise recurring units deriving from the group consisting of non-fluorinated, fluorinated, perfluorinated monomers and mixtures thereof.

In a preferred embodiment the polymer chains covalently anchored to the surface of the solid substrate comprise recurring units deriving from fluorinated and/or perfluorinated monomers.

The solid substrate is preferably an inorganic substrate.

Of particular interest are polymer brush composites comprising anchored polymer chains comprising monomeric units deriving from tetrafluoroethylene, hexafluoropropylene, vinylidene fluoride, chlorotrifluoroethylene and fluoroalkylvinylethers of formula CF₂═CFOR_{f1} as discussed above. Mention can be made of polymer chains comprising recurring units deriving from vinylidene fluoride and optionally between 0.1 and 15% by moles of one or more fluorinated comonomer(s), such as tetrafluoroethylene and/or hexafluoropropylene; polymer chains comprising recurring units deriving from vinylidene fluoride and acrylic monomers; polymer chains comprising recurring units deriving from tetrafluoroethylene and at least one fluorinated comonomer chosen among the group consisting of perfluoroalkylvinylethers or perfluoro-oxyalkylvinylethers.

The polymer brush can be tailored to provide optimal properties to the composite such as improved wettability, improved affinity for specific substrates, for instance by introducing specific functional groups in the polymer brush, or increased water- and/or oil repellency.

The thickness of the polymer layer can be controlled by varying the polymer chain length and the surface density of initiator sites.

The polymer chains in the polymer brush composite of the present invention can have a variety of molecular weights. In some aspects, the molecular weight may depend on the amount of initiator used, or the addition of chain terminating agents as well known in the field of free radical polymerization reactions.

The surface-bound polymer chains typically have a weight average molecular weight of at least 100, preferably of at least 500 and more preferably of at least 1,000. Depending upon their particular use, the surface-bound polymer chains may have a weight average molecular weight of up to 10,000, preferably of up to 50,000, more preferably of up to 100,000; in some instances they may have a weight average molecular weight of up to 200,000, even up to 400,000 or even up to 1,000,000.

An additional object of the invention is a composition comprising polymer brush composites.

Of particular interest are compositions comprising the polymer brush composites of the invention and at least one polymer. Typically, the composition comprises from 0.01 to 90 weight % of the polymer brush composite. The polymer may have the same or different composition than the polymer chains anchored to the solid substrate in the polymer brush composite. In some instances it may be advantageous to prepare compositions wherein the at least one polymer and the polymer chains anchored to the polymer brush composite have the same chemical nature.

Suitable polymers for the preparation of compositions comprising the polymer brush composite are for instance non-fluorinated polymers such as ethylene homo- and/or copolymers, propylene homo- and/or copolymers, polyamides, polyesters, styrene homo- and/or copolymer including styrene-butadiene, styrene-isoprene block copolymers.

Notable examples of fluorinated and perfluorinated polymers are for instance copolymers of tetrafluoroethylene and hexafluoropropylene, copolymers of tetrafluoroethylene and perfluoromethylvinylether, copolymers of vinylidene fluoride and chlorotrifluoroethylene, copolymers of ethylene and chlorotrifluoroethylene, copolymers of tetrafluoroethylene, hexafluoropropylene and vinylidene fluoride, poly(vinylidene fluoride).

Among the properties that the polymer brush composite may impart to the composition mention can be made of fire retardancy, biocompatibility, hydrophilicity or hydrophobicity, selective permeation properties, conductivity.

Both the polymer brush composite and the compositions obtained therefrom are particularly useful in the preparation of paints, coatings, varnishes, inks and toners.

The polymer brush composite and the compositions obtained therefrom could also suitably be used in the preparation of mortars, cements, asphalts.

Additionally, the polymer brush composite and the compositions obtained therefrom could also suitably be used in the preparation of membranes for filtration purposes.

Should the disclosure of any patents, patent applications, and publications which are incorporated herein by reference conflict with the description of the present application to the extent that it may render a term unclear, the present description shall take precedence.

The invention will be now described with reference to the following examples whose purpose is merely illustrative and not limitative of the present invention.

### EXAMPLES

All materials were purchased from Aldrich® and used as received.

Analytical Methods

Infrared analysis: solid substrates were characterized using the DRIFT technique (Diffuse reflectance infrared Fourier transform spectroscopy) on a FT-IR Nicolet 20SX instrument with a resolution of 2 cm⁻¹ and 512 scans. ¹⁹F-NMR and ¹H-NMR: were recorded at room temperature using CFCl₃ as internal standard. Instrument: Varian Inova 400 MHz

Determination of the number of vinyl groups chemically bonded to the silica surface: the following procedure was used: 1 g of vinyl functionalized silica powder was mixed with 20 g of ethyl acetate and kept under stirring in a glass flask covered with aluminum foil to avoid the exposition to solar light. After 1 hour a homogeneous dispersion (a) was obtained; 10 ml of an aqueous solution of bromine (previously prepared by dissolution of 35.8 g of KBr and 17.2 g of Br₂ in 100 ml of water) were added to dispersion (a) and kept under stirring for 1 hour; 20 ml of an aqueous solution of NaI (20% w/w) were added in excess. The I₃_{^{−}}, formed by reaction with the excess of bromine, was titrated with sodium tiosulfate, according to the following reaction;

I₃+2S₂O₃²⁻→3I⁻+S₄O₆²⁻

### Example 1

### Preparation of Silica Nanopowder Functionalized with Vinyl Groups

200 g of toluene and 3 g of chlorodimethyl vinyl silane were introduced in a 3 necked glass flask and kept under stirring under moderate flow of nitrogen. After 10 minutes, 10 g of fumed silica (surface area=200 m²/g; OH content: 6,6*10⁻³ mmol/m²) were gradually added and the obtained dispersion was heated at 60° C. for 10 hours under stirring. The solvent and the unreacted silane were removed by fractional distillation under vacuum and a white powder was obtained as residue. The presence of vinyl groups on the silica surface was confirmed by IR analysis and quantified according to the method described above (=0.25 mmol of vinyl group/g of powder).

### Example 2

### Preparation of Silica Nanopowder Functionalized with the Borane Initiator

In a dry-box 1 g of the modified silica described in Example 1 was mixed with 18 g of anhydrous THF (previously degassed to remove any trace of oxygen) until a homogeneous dispersion was obtained. 0.45 g of a solution of 9-H-9-borabicyclo[3,3,1]nonane (9-BBN) 0.5 M in THF (=0.25 mmol) were added and the mixture was stirred for 1 hour. The dispersion was removed from the dry-box and subjected to fractional distillation to recover the modified powder. IR analysis showed the disappearance of the band of the vinyl groups, thus indicating a complete conversion in the reaction with 9-BBN.

### Example 3

### Polymerization of Methyl Methacrylate with Silica Nanopowder Functionalized with Organoborane Groups

Following the procedure of Example 2 a composite polymerization initiator was prepared starting from the modified silica described in Example 1 and 9-BBN. It was used without further purification.

25 g of methyl methacrylate were then added to the reaction mixture containing the composite polymerization initiator, that was kept under stirring for 10 hours at room temperature. During this period, controlled amounts of oxygen were fed into the reaction system (step addition of 0.5 ml of oxygen=0.02 mmol every hour). The reaction mixture was maintained under stirring without any further oxygen addition for other 10 hours, always at room temperature, and then subjected to fractional distillation. A solid polymeric material was obtained as residue; it was identified as poly(methyl methacrylate) by NMR analysis.

### Example 4

### Comparative

A solution of methyl methacrylate (25 g) and THF (18 g) is kept under stirring for 20 hours at room temperature. At the end, the reaction mixture was subjected to fractional distillation but no residue was obtained (absence of poly(methyl methacrylate).

### Example 5

### Polymerization of Vinylidene Fluoride with with Silica Nanopowder Functionalized with Organoborane Groups

Following the procedure of Example 2 a composite polymerization initiator was prepared starting from the modified silica described in Example 1 and 9-BBN. It was used without further purification.

The reaction mixture containing the composite polymerization initiator is transferred into a 3 necked flask and taken out of the dry-box. One neck of the flask is connected to a cylinder containing vinylidene fluoride, another is connect with a syringe containing 5 m of oxygen and the remaining neck is used for the outlet of gases.

Under stirring and at room temperature 1 NI/h of vinylidene fluoride is fed into the reaction mixture for 20 hours. Simultaneously, during the first 10 hours, oxygen is fed into the reaction mixture (step addition: 0.5 ml/hour). At the end, the reaction mixture is vented with a nitrogen flow and poly(vinylidene fluoride) is obtained.

1. A composite polymerization initiator comprising groups of formula (1) covalently anchored to the surface of a solid substrate:
-(L)ₙ-CR₂—B(R_{B1})₂ (1)
wherein L is a linker group, n is equal to 0 or 1; each R is independently selected from the group consisting of hydrogen, C₁-C₁₅ linear or branched alkyl group, optionally comprising heteroatoms; and wherein each R_{B1} is independently selected from the group consisting of hydrogen, C₁-C₂₀ linear, branched or cyclic alkyl group, C₅-C₁₀ aromatic group, optionally fluorinated; each group R_{B1} may be comprised in an, optionally substituted, aliphatic or aromatic cyclic structure; and wherein said —B(R_{B1})₂ may be an aliphatic bicyclic borane radical wherein both boron-carbon bonds are part of a cyclic structure.

2. A method for the preparation of the composite initiator of claim 1 comprising the steps of: (a) providing a solid substrate comprising surface reactive groups GSR; said
(b) reacting the solid substrate with a compound comprising one functional group X capable of forming a covalent bond with the substrate surface by reaction with the surface reactive groups GSR, and at least one functional group either comprising a moiety of formula —CR₂—B(R_{B1})₂ or capable of forming a moiety —CR₂—B(R_{B1})₂ by reaction with an organoborane of formula B(R_{B1})₂R_{B2}, wherein R and R_{B1} are as defined in claim 1 and R_{B2} is selected from the group consisting of hydrogen, halogen, said C₁-C₅ linear or branched alkyl.

3. The method according to claim 2 comprising the step of reacting the solid substrate with a linker compound of formula X-(L′)ₙ-Yₐ comprising one functional group [X] capable of forming a covalent bond with the substrate surface by reaction with the surface reactive groups GSR, and at least one functional group Y capable of forming a carbon-boron bond by reaction with an organoborane of formula B(R_{B1})₂R_{B2} to obtain a solid substrate comprising groups -(L′)ₐ-Yₐ anchored to its surface, wherein L′ is a linker group and a≧1; and
(c) reacting the solid substrate comprising said groups -(L′)ₐ-Yₐ anchored to its surface with an organoborane of said formula B(R_{B1})₂R_{B2}.

4. The method according to claim 2 comprising the step of reacting the solid substrate with a compound of formula X-(L)ₐ-CR₂B(R_{B1})₂ comprising one functional group [X] capable of forming a covalent bond with the substrate surface by reaction with the surface reactive groups GSR and at least one organoborane moiety of formula —CR₂—B(R_{B1})₂.

5. A method for preparing a polymer brush composite comprising the step of contacting the composite initiator of claim 1 with monomers capable to polymerize via a free radical route under conditions that promote free radical polymerization from the organoborane sites of the initiator to form a polymer brush.

6. The method according to claim 5 carried out in the presence of oxygen.

7. A polymer brush composite obtainable from the method of claim 5 comprising polymer chains covalently anchored to the surface of a solid substrate by means of groups of formula -((L)ₙ-CR₂)—, wherein L is a linker group, n is equal to 0 or 1; each R is independently selected from the group consisting of hydrogen, C₁-C₁₅ linear or branched alkyl group, optionally comprising heteroatoms.

8. The polymer brush composite according to claim 7 wherein the polymer chains comprise recurring units deriving from non-fluorinated, fluorinated, perfluorinated monomers and their mixtures.

9. The polymer brush composite according to claims 7 wherein the polymer chains comprise recurring units deriving from vinylidene fluoride and/or acrylic monomers.

10. The composite polymerization initiator, of claim 1 wherein n=1, L has formula -A-Si(R_{N})_{3-b}(A′-CRR_{B2})_{b}- and -(L′)-Yₐ has formula -A-Si(R_{N})_{3-b}(A′-CR═CR₂)_{b}, wherein each —R_{N} equal or different from each other, is a non-hydrolyzable group, and R as defined in claim 1 and R_{B2} is slected from the group consisting of hydrogen, halogen, C₁-C₅ linear or branched alkyl; and wherein b is an integer from 1 to 3; and wherein A and A′, optionally present, equal or different from each other, are independently selected from the group consisting of C₁-C₁₀ alkyl, optionally substituted and/or optionally fluorinated and/or optionally comprising oxygen atoms in the chain, C₆-C₂₀ arylene or heteroarylene, —Si(R_{N})₂—, and an amino radical.

11. The composite polymerization initiator, of claim 1 wherein the solid substrate is an inorganic substrate.

12. Compositions comprising the polymer brush composite of claim 7 and at least one polymer.

13. Compositions according to claim 12 wherein the at least one polymer and the polymer chains of the polymer brush composite comprises recurring units deriving from fluorinated and/or perfluorinated monomers.

14. A method for the preparation of paints, coatings, varnishes, inks and toners comprising the step of using the polymer brush composite of claim 7.

15. A method for the preparation of membranes for filtration purposes comprsing the step of using the polymer brush composite of claim 7.

16. The method according to claim 2 wherein n=1, L has formula -A-Si(R_{N})_{3-b}(A′-CRR_{B2})_{b}— and —(L′)-Yₐ has formula -A-Si(R_{N})_{3-b}(A′-CR═CR₂)_{b}, wherein each R_{N}, equal or different from each other, is a non-hydrolyzable group, and R is independently selected from the group consisting of hydrogen, C₁-C₁₅ linear or branched alkyl group, optionally comprising heteroatoms; and R_{B2} is selected from the group consisting of hydrogen, halogen, and C₁-C₅ linear or branched alkyl; and wherein b is an integer from 1 to 3; and wherein A and A′, optionally present, equal or different from each other, are independently selected from the group consisting of C₁-C₁₀ alkyl, optionally substituted and/or optionally fluorinated and/or optionally comprising oxygen atoms in the chain, C₆-C₂₀ arylene or heteroarylene, —Si(R_{N})₂—, and an amino radical.

17. The polymer brush composite according to claim 7 wherein n=1, L has formula -A-Si(R_{N})_{3-b}(A′-CRR_{B2})_{b}— and -(L′)-Yₐ has formula -A-Si(R_{N})_{3-b}(A′-CR═CR₂)_{b}, wherein each R_{N}, equal or different from each other, is a non-hydrolyzable group and R is independently selected from the group consisting of hydrogen, C₁-C₁₅ linear or branched alkyl group, optionally comprising heteroatoms and R_{B2} is selected from the group consisting of hydrogen, halogen, and C₁-C₅ linear or branched alkyl; and wherein b is an integer from 1 to 3; and wherein A and A′, optionally present, equal or different from each other, are independently selected from the group consisting of C₁-C₁₀ alkyl, optionally substituted and/or optionally fluorinated and/or optionally comprising oxygen atoms in the chain, C₆-C₂₀ arylene or heteroarylene, —Si(R_{N})₂—, and an amino radical.

18. The method according to claim 2 wherein the solid substrate is an inorganic substrate.

19. A method for the preparation of paints, coatings, varnishes, inks and toners comprising the step of using the polymer brush composite of claim 12.

20. A method for the preparation of membranes for filtration purposes comprsing the step of using the polymer brush composite of claim 12.
